(19) United States
(12) Patent Application Publication
(10) Pub. No.: US 2020/0310764 A1
(43) Pub. Date: Oct. 1, 2020

(54) VEHICLE ENTERTAINMENT SYSTEM INTERACTIVE USER INTERFACE CO-DEVELOPMENT ENVIRONMENT

(71) Applicant: Panasonic Avionics Corporation, Lake Forest, CA (US)

(72) Inventor: Fouzi Djaafri, Dubai (AE)

(21) Appl. No.: 16/697,044

(22) Filed: Nov. 26, 2019

Related U.S. Application Data
(60) Provisional application No. 62/878,013, filed on Jul. 24, 2019.
(60) Provisional application No. 62/826,839, filed on Mar. 29, 2019.

(51) Int. Cl. G06F 8/38; G06F 8/34; H04L 29/06; G06F 11/36

(52) U.S. Cl. CPC G06F 8/38; G06F 8/34; G06F 11/3664; G06F 11/3684; H04L 63/105

(57) ABSTRACT

A co-development platform for a graphical user interface to a system interaction application of a terminal device for a vehicle entertainment system. A terminal hardware emulator has an emulated data processor executing software instructions of the system interaction application. A display terminal emulator generates an output corresponding to the graphical user interface, and is selectively targeted to device parameters specific to the terminal device. The display terminal emulator is also receptive to test inputs to one or more input-receptive graphic elements in the graphical user interface. A graphical user interface editor includes one or more interface element settings modifiable by a test user. A test user access controller defines access privilege levels for the test users, which are selectively restricted and permitted to access one or more functionalities.

### CROSS-REFERENCE TO RELATED APPLICATIONS

This application relates to and claims the benefit of U.S. Provisional Application No. 62/826,839 filed Mar. 29, 2019 and entitled “VIRTUALIZATION OF COMPLEX NETWORKED EMBEDDED SYSTEMS,” and U.S. Provisional Application No. 62/878,013 filed Jul. 24, 2019 and entitled “VEHICLE ENTERTAINMENT SYSTEM INTERACTIVE USER INTERFACE CO-DEVELOPMENT ENVIRONMENT,” the entire disclosure of each which are wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to vehicle-installed electronics systems such as in-flight entertainment and communications systems, and more particularly, to interactive, cloud-based user interface co-development environments and hardware emulators therefor.

### 2. Related Art

Air travel typically involves journeys over extended distances that at the very least take several hours to complete. Airlines thus provide onboard in-flight entertainment and communications (IFEC) systems that offer a wide variety of multimedia content for passenger enjoyment. Recently released movies are a popular viewing choice, as are television shows such as news programs, situation and stand-up comedies, documentaries, and so on. Useful information about the destination such as airport disembarking procedures, immigration and custom procedures and the like are also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger.

The specific installation may vary depending on service class, though in general, each passenger seat is equipped with a display device, an audio output modality, an input modality, and a terminal unit. The terminal unit may generate video and audio signals, receive inputs from the input modality, and execute pre-programmed instructions in response thereto. The display device is typically an LCD screen that is installed on the seatback of the row in front of the passenger, though in some cases it may be mounted to a bulkhead or retractable arm, or the like, that is in turn mounted to the passenger's seat. Furthermore, the audio output modality is a headphone jack, to which a headphone, either supplied by the airline or by the passenger, may be connected. Inputs to the terminal unit may be provided via a separate multi-function remote controller or by via a combination touch display. Although the terminal unit and display device were separate components in earlier IFEC implementations, more recently, these components and more may be integrated into a single smart monitor.

The multimedia content is encoded and stored as digital data, with a video decoder and audio decoder of the terminal unit functioning to generate the aforementioned video and audio signals therefrom. It is desirable to have a wide range of different multimedia content to satisfy the varying tastes of passengers. It is also desirable to have a sufficient volume of multimedia content so that passengers can remain occupied with entertainment for the entire duration of the flight. This data may be stored on a central content server, with each terminal unit including networking modalities such as Ethernet to establish a data communications link to the central content server. Following retrieval, the multimedia content data is decoded and presented on the display device.

Modern IFEC systems are thus comprised of multiple tiers of interconnected systems, including one or more IFEC head end servers, intermediary network switches, and each of the individual smart monitors for all of the passenger seats of the aircraft. Each of these components have specific software applications loaded thereon performing a variety of functions. The smart monitor in particular may incorporate a menu application allowing the user to navigate through the available selection of multimedia content, as well as the aforementioned game, mapping, and other informational applications.

Before deploying an IFEC system to a particular aircraft, or a fleet of aircraft, extensive testing is conducted to ensure that all of the components thereof are operational and function without fault or errors. Furthermore, the development of passenger-facing interfaces may undergo several iterations of development involving multiple individuals and/or organizations. For instance, the provider of the IFEC system may offer a reference/baseline design, and the carriers may customize the user interface to match its corporate identity and offer functionalities that help distinguish the carrier over competitors in its IFEC offerings. These changes may be requested by the carrier for the provider to make, and there may be multiple review/approval steps before final deployment to the aircraft or fleet. The testing and demonstration of such user interface designs are typically performed on test racks configured as a closed physical facsimile of the actual aircraft installation, including a replicated IFEC head-end server, networking devices, smart monitors, and wiring. Thus, there may be extensive delays associated with the iterative testing, review, and approval process, in spite of the need for such changes to the IFEC user interface to be installed on a fleet of operating aircraft as quickly as possible.

Presently, a commonly accessible platform/service for collaborators from multiple organizations and organization levels to create IFEC user interface experiences is lacking, since media operations, themes, and user experience content updates are typically executed on different tracks, with separate development tools for each. Usability consensus of new user interface designs are achieved via surveys, and the applications therefor are typically hosted in still another platform and hence disconnected from the development process. Accordingly, there is a need in the art for a tool for visually creating the interactive software user interface elements for an IFEC system, and shortens the cycle of changes and delivery of the same to operating aircraft, while accommodating existing review, approval, and validation procedures involved therewith. There is also a need in the art for such tools to be accessible from different devices such as mobile phones, tablets, and laptop computers regardless of geographic location. There is additionally a need to combine software development (Dev) and information technology operations (Ops) to shorten the systems development cycle for IFEC software for interactive Ops and/or DevOps.

### BRIEF SUMMARY

The cloud-based user interface co-development environment and hardware emulation platform enables the seamless and transparent co-creation and collaboration on the IFEC user interface design process, particularly in the continuous updating of designs as driven by passenger experience research. The co-development platform of the present disclosure is envisioned to increase flexibility for personnel at all levels of the interactives development process including the airline/customer, and managers, installers, technicians and the like working for the service provider to build, test, troubleshoot, compare, and contrast the interactives of an IFEC graphical user interface, including past or legacy interactives, presently deployed interactives, and future interactives for deployment on new IFEC hardware and software.

According to one embodiment, there is a co-development platform for a graphical user interface to a system interaction application of a terminal device for a vehicle entertainment system. The co-development platform may have a terminal hardware emulator including an emulated data processor that executes software instructions corresponding to the system interaction application. Additionally, the co-development platform may include a display terminal emulator that generates an output corresponding to the graphical user interface. The output may be selectively targeted to device parameters specific to the terminal device. The display terminal emulator may also be receptive to test inputs to one or more input-receptive graphic elements in the graphical user interface. The test inputs may be translated to inputs to the emulated graphical user interface, and then processed by the terminal hardware emulator to modify the execution of the system interaction application in response. There may also be a graphical user interface editor including one or more interface element settings modifiable by a given one of one or more logged in test users. The co-development platform may further include a test user access controller that defines access privilege levels for each of the test users. A given one of the test users may selectively restricted and permitted to access one or more functionalities of the display terminal emulator and the graphical user interface editor based upon the associated access privilege levels.

Another embodiment may be an in-flight entertainment terminal user interface virtualized development system. The system may include a virtual machine instance that simulates physical hardware components of a terminal to execute software instructions corresponding an in-flight entertainment system interaction application. The virtual machine instance may be defined by device parameters specific to the terminal. There may also be a display emulator that is connected to the virtual machine instance. Display outputs corresponding to a graphical user interface of the in-flight entertainment system interaction application as generated by the virtual machine instance may be presented by the display emulator. The display emulator may also be receptive to test user inputs to one or more input-receptive graphic elements in the graphical user interface. The test user inputs may further be relayed to the virtual machine instance to modify execution of the in-flight entertainment system interaction application. The system may also include a virtual machine access controller that regulates access to the virtual machine instance by one of a plurality of test users, each of which may be associated with an account with predefined access privilege levels. There may also be a testing platform that is connected to the virtual machine instance to deploy interactive elements of the graphical user interface for the in-flight entertainment system interaction application. Such interactive elements may be displayed by the display emulator.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram illustrating an exemplary aircraft in which an in-flight entertainment and communications system is installed;

FIG. 2 is a block diagram of an co-development platform for a graphical user interface to a system interaction application of an in-flight entertainment and communications system terminal device according to one embodiment of the present disclosure;

FIG. 3 is a screen capture of an exemplary client interface for the co-development platform in which a user is prompted to provide login credentials;

FIG. 4 is a screen capture of another exemplary client interface for the co-development platform of the present disclosure with an output of a display terminal emulator being presented;

FIG. 5 is a screen capture of an exemplary client interface for the co-development platform with an output of a change request processor being presented;

FIG. 6 is a screen capture of another exemplary client interface for the co-development platform with an output of a display terminal emulator being presented;

FIG. 7 is a screen capture of another exemplary client interface for the co-development platform with an output of an analytics processor being presented;

FIG. 8 is a screen capture of an exemplary client interface for the co-development platform presented on a mobile device to launch a test display terminal emulator;

FIG. 9 is a detailed block diagram showing one implementation of a co-development platform front end;

FIG. 10 is a detailed block diagram showing administrative console components of the co-development platform front end;

FIG. 11 is a block diagram showing the virtualization features of the co-development platform when accessed with a standard web client;

FIG. 12 is a block diagram showing the virtualization features of the co-development platform when accessed with a VNC (virtual network computing) client, including the additional components utilized in such virtualization platform; and

FIG. 13 is a block diagram showing the virtualization features of the co-development platform when accessed with a WebGL client, including the additional components utilized in such virtualization platform.

### DETAILED DESCRIPTION

The detailed description set forth below in connection with the appended drawings is intended as a description of the several presently contemplated embodiments of an interactive, cloud-based user interface co-development environment, including hardware emulators for the same. This description is not intended to represent the only form in which the embodiments of the disclosed system may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

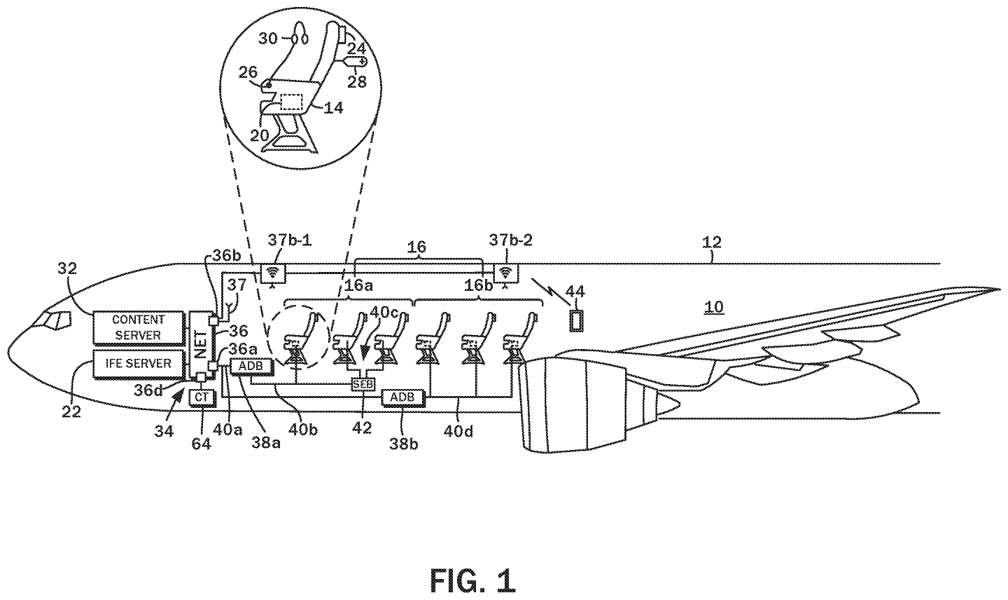

FIG. 1 is a simplified diagram of an aircraft 10, generally referred to herein as a vehicle, along with select subsystems and components thereof. Within a fuselage 12 of the aircraft 10, there may be seats 14 arranged over multiple rows 16, with each seat 14 accommodating a single passenger. Although the features of the present disclosure will be described in the context of the aircraft 10, this is by way of example only and not of limitation. The presently disclosed embodiments of the user interface co-development environment may be applicable to other contexts as appropriate, such as, by way of non-limiting illustrative example, busses, trains, ships, and other types of vehicles.

Installed in the aircraft 10 is an in-flight entertainment and communications (IFEC) system 18, through which various entertainment and connectivity services may be provided to passengers while onboard. When referenced generally, the IFEC system 18 is understood to encompass terminal devices 20 installed for each seat 14, as well as the IFEC server 22 and the other components involved in the delivery of the entertainment and communications functionality. In the illustrated example, this includes a display 24, an audio output 26, and a remote controller or handset 28. For a given row 16 of seats 14, the terminal device 20 and the audio output 26 are disposed on the seat 14 for which it is provided, but the display 24 and the handset 28 may be located on the row 16 in front of the seat 14 to which it is provided. That is, the display 24 and the handset 28 are installed on the seatback of the row in front of the seat. Other display 24 and handset 28 mounting and access configurations such as a retractable arm or the like mounted to an armrest of the seat 14 or by mounting on a bulkhead are also possible.

The display 24 is understood to be a conventional liquid crystal display (LCD) screen or other type with a low profile that is suitable for installation on the seatback. Each passenger can utilize an individual headset 30, supplied by either the airline or by the passenger, which provides a more private listening experience. The audio output 26 may be a headphone jack that is a standard ring/tip/sleeve socket. The headphone jack may be disposed in proximity to the display 24 or on the armrest of the seat 14 as shown. The headphone jack may be an active type with noise canceling and including two or three sockets or a standard audio output without noise canceling. Each display 24 may incorporate the aforementioned terminal device 20 to form a unit referred to in the art as a smart monitor.

A common use for the terminal device 20 installed on the aircraft 10 is the playback of various multimedia content. The terminal device 20 may be implemented with a general-purpose data processor that decodes the data files corresponding to the multimedia content and generates video and audio signals for the display 24 and the audio output 26, respectively. The multimedia content data files may be stored in one or more content servers 32, and streamed to specific terminal devices 20 upon request. The content may be encrypted, so the digital rights management functionality to enable streaming/playback may be performed by the IFEC server 22. Functionality not pertaining to the delivery of multimedia content, such as relaying imagery from external aircraft cameras, flight path/mapping information, and the like may also be performed by the IFEC server 22.

The passenger can play games being executed on the terminal device 20 and otherwise interact with the multimedia content with the handset 28. Navigating through the vast multimedia content library and selecting ones for viewing and/or listening is also possible with the handset 28, though in some different installations, a touch-screen display may be provided for a more intuitive interaction with the multimedia content library. In either case, the terminal device 20 is loaded with a content selection software application that is executed by the data processor and accepts input from the handset 28 or other input modality and generates a response on the graphical interface presented on the display 24.

Each of the terminal devices 20 for the seats 14 may be connected to the IFEC server 22, the content server 32, or any other server that is part of the IFEC system 18 over a local area network 34, one segment of which may preferably be Ethernet. The IFEC system 18 thus also includes a data communications module 36, and more specifically, an Ethernet data communications module 36a, e.g., an Ethernet switch or router. In a typical aircraft installation, the data communications module 36 is understood to be a separate line replaceable unit (LRU), and may also be referred to as a network controller (NC). Likewise, the IFEC server 22, the content server 32, and the other servers onboard the aircraft 10 are understood be standalone computer systems with one or more general purpose data processors, memory, secondary storage, and a network interface device for connecting to the local area network 34. The computer systems may have an operating system installed thereon, along with server applications (e.g., web servers, streaming servers, and so forth) providing various in-flight entertainment/communications services in cooperation with the terminal devices 20 connected thereto. In particular, there may be a cataloging/menu application with which the user interacts to select the desired multimedia content.

The local area network 34 may be logically separated into tiered segments, with the network controller/data communications module 36 being at the top of the hierarchy or central to all of the segments. The smart monitors/terminal devices 20 may be organized according to sections, rows, or columns of seats 14, and the local area network 34 may be structured accordingly.

There may be a first area distribution box (ADB) 38a, which may also be a line replaceable unit that is directly connected to the network controller/data communications module 36 and establishes a segment of the local area network 34 for a first set of rows 16a. Connected to the first ADB 38a over a downstream network segment 40b may be the smart monitors/terminal device 20. In some implementations, there may be an additional seat electronic box (SEB) 42 that handles some data processing operations shared amongst multiple smart monitors. The further downstream network segments 40c may be shared with the peripheral devices connected to the smart monitor such as a credit card reader on the handset 28, a USB port, and the like.

A second ADB 38b is also directly connected to the network controller/data communications module 36, and is also part of the same network segment 40a. The second ADB 38b is understood to be dedicated for the second set of rows 16b, with individual connections to each of the smart monitors/terminal devices 20 defining a network segment 40d. Although different network segmentation hierarchies are illustrated, for example, one set of seats 14 being connected to an SEB 42, which in turn is connected to the ADB 38a, along with a direct connection between the smart monitor/terminal device 20 to the ADB 38b, a typical aircraft configuration will be consistently structured.

Passengers and cabin crew alike may utilize a portable electronic device (PED) 44 during flight. PEDs 44 are understood to refer to smart phones, tablet computers, laptop computers, and other like devices that include a general purpose data processor that executes pre-programmed instructions to generate various outputs on a display, with inputs controlling the execution of the instructions. Although these devices are most often brought on board the aircraft 10 by the passengers themselves, carriers may also offer them to the passengers for temporary use.

Conventional PEDs 44 are understood to incorporate a WLAN (WiFi) module, so the data communications module 36 of the IFEC system 18 includes a WLAN access point 37 that is connected over a local wireless network interface 36b. The PED 44, via the onboard WLAN network, may connect to the IFEC 18 to access various services offered thereon such as content downloading/viewing, shopping, and so forth. Typically, a single WLAN access point 37 is insufficient for providing wireless connectivity throughout the cabin, so additional WLAN access points 37b-1, and 37b-2 may be installed at various locations spaced apart from each other. These additional WLAN access points 37b-1 and 37b-2 may be connected to the network controller/data communications module 36 over an Ethernet link that is part of the aforementioned local area network 34. The local area network interface or data communications module 36 is understood to encompass the hardware components such as the WLAN transceiver, antennas, and related circuitry, the Ethernet router/switch, as well as the software drivers that interface the hardware components to the other software modules of the IFEC system 18.

Due to the speed/bandwidth limitations associated with current implementations of WiFi and other wireless data networking modalities, the communications between each of the terminal devices 20 and the IFEC server 22, content server 32, and other servers is understood to be over the wired local area network 34. However, it will be appreciated that this is by way of example only and not of limitation. Future wireless networking modalities may bring substantial improvements in transfer speed and available bandwidth such that all of the terminal devices 20 are connected wireless. Indeed, this would be desirable because in the weight-restricted context of aircraft installations, the elimination of cables and associated switch/router interfaces would improve aircraft operational efficiency. In this regard, the alternative WiFi data communications module 36b is being presented to illustrate the possibility of utilizing other data networking modalities beyond the wired local area network 34.

The foregoing arrangement of the IFEC system 18, along with its constituent components, have been presented by way of example only and not of limitation. Other aircraft 10 may have any number of different configurations, and may incorporated components that were not mentioned above, or functions may be handled by a different subpart or component than that to which above description attributes. Along these lines, features described above may be omitted from such different configurations.

As indicated above, the passenger may view multimedia content stored on the IFEC system 18 via the display 24 connected to the terminal device 20/smart monitor. Before playback can be initiated, the user is understood to make a selection of the desired multimedia content through a system interaction application that, among performing other functions, generates an interactive listing of available content. A brief text synopsis may be presented together with the title of the work, the starring actors, the runtime, the rating, as well as an icon or other graphical element from a promotional item associated with such selection. The content items may be grouped into types (such as television shows, movies, music, etc.) as well as genres and categories (such as comedies, action, documentaries, etc.). By way of example only, each type of content may be presented in a separate “tab” window, whereas content genres and categories may be grouped into a separate, independently scrollable rows. Beyond movies and television shows, games, navigation applications, destination information applications, and so on may also be used via the smart monitor, so such content may be segregated into further sections.

The system interaction application is a software application that is targeted to run on a general-purpose operating system/platform, with the specific code thereof being stored in the memory of the terminal device 20 and executed by its processor. In a typical implementation, the smart monitor is configured with the Android operating system, though this is by way of example only and not of limitation.

The system interaction application has a graphical user interface including various static graphic elements, as well as input-receptive graphic elements. The appearance of such graphic elements is understood to be configured by the carrier to thematically match, for example, a corporate identity. In this regard, palettes of common colors may be applied to the various components of the graphical user interface, as well as utilize shared graphic assets such as logos, typefaces/fonts, background images, and the like. The structure and arrangement of the static graphic elements and the input-receptive graphic elements may be configured as desired by the carrier as well. For the sake of convenience, all such configurable elements of the graphical user interface may be referred to generally as interactives.

Although the primary interface to the system interaction application is that which is presented on the terminal device 20/smart monitor, the handset 28 may also incorporate a input-receptive display that may be used to present a truncated graphical user interface. Within such a reduced size interface, the same or similar interactives may be presented. Beyond these line-replaceable units that are installed in the aircraft 10, a passenger's PED 44 may be another modality by which multimedia content may be retrieved and presented. In such implementations, a graphical user interface rendered within a web browser or a natively installed application is possible, utilizing the same or similar interactives.

Upgrades of line replaceable units in a commercial aircraft fleet are typically staggered, so various aircraft may have different hardware and software versions of the IFEC system 18 installed thereon. This includes smart monitors of different processor power, memory capacity, display sizes and/or resolutions, and operating systems and/or versions. The present disclosure contemplates an integrated co-development platform to configure and modify configurations of the graphical user interfaces to the system interaction application, and more generally to the IFEC system 18.

As discussed earlier, many different personnel from the IFEC system provider and the carrier are involved in the process of requesting modifications to the interactives, implementing those modifications for approval, securing the approval of the appropriate personnel from the carrier, and then rapidly deploying the updated interactives to the entire fleet. To the extent there are interactives specific to a terminal device configuration, whether such configuration involves a particular operating system, display size/capability or otherwise, the co-development platform is understood to be capable of managing the process for all such variants in accordance with the embodiments of the present disclosure. The co-development platform combines Dev and Ops and shortens the systems development cycle for IFEC software by creating Ops and/or DevOps for the creation and modification of interactives. This enables continuous interactive integration and deployment pipelines from customer initiation to production deployment.

The team of personnel working on this process may be dispersed across wide geographic areas, so the embodiments of the present disclosure may be implemented as an Internet-accessible service, also referred to in the art as a cloud-based implementation. Furthermore, as will be described in further detail below, rather than utilizing actual smart monitors and other IFEC system 18 hardware as would be installed onboard the aircraft 10 including the IFEC server 22, networking equipment such as the data communications module 36, area distribution boxes 38 and the like, the present disclosure contemplates the virtualization of such components and running the software of such components within constraints defined within the virtualization environment. In addition to the heterogeneity with respect to the target graphical user interfaces, those personnel accessing the co-development platform may utilize a wide range of computing devices from desktop workstations, laptop computers, to mobile devices including tablets and smartphones, so each such processing and display capability may be accommodated. Thus, personnel are enabled to co-create and collaborate on changing IFEC system interactives efficiently and transparently.

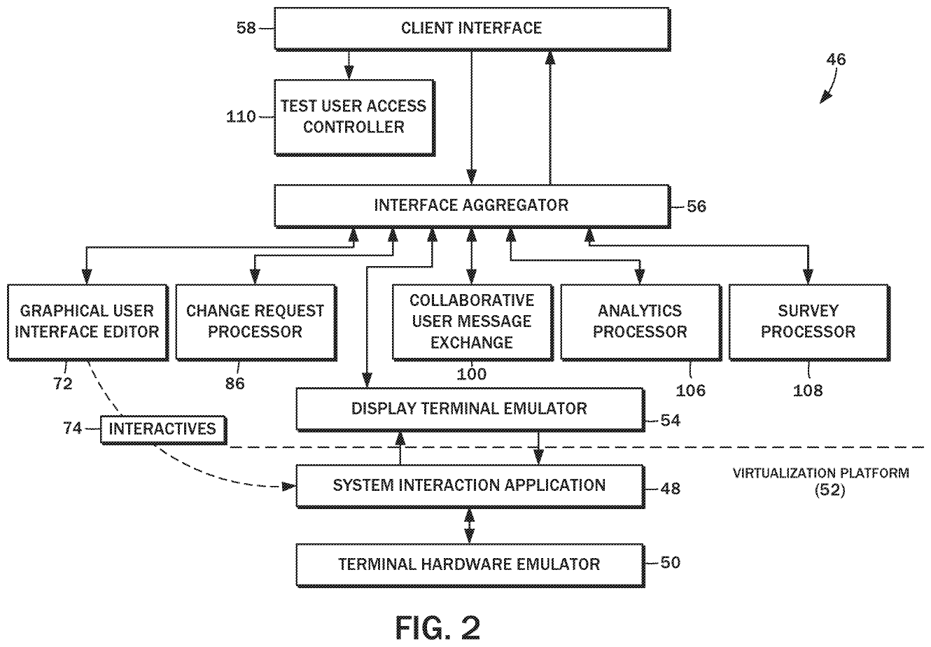

Referring now to the block diagram of FIG. 2, an embodiment of the present disclosure is directed to a co-development platform 46 for a graphical user interface. This graphical user interface may be for an IFEC system interaction application 48 that is being executed on a terminal hardware emulator 50. Additional details of the terminal hardware emulator 50 will be provided below, though in on implementation, it may be running on a virtualization platform 52 with a cluster of general-purpose computer servers that include, at a minimum, a processor and a memory. The virtualization platform 52 may include a hardware abstraction layer that imposes a various performance constraints and parameters in relation to the execution of the software code of the system interaction application 48 and outputs generated thereby, such that it matches the same constraints and parameters as an actual physical hardware device of the terminal device 20. In this regard, the terminal hardware emulator may include an emulated data processor that executes the instructions comprising the system interaction application 48. This also includes generating outputs within the display size and resolution limits of the counterpart terminal device 20. These constraints may be generally referred to as device parameters and are understood to be specific to a particular embodiment of the physical terminal device 20. The virtualization may employ virtual machines or container technology as described below.

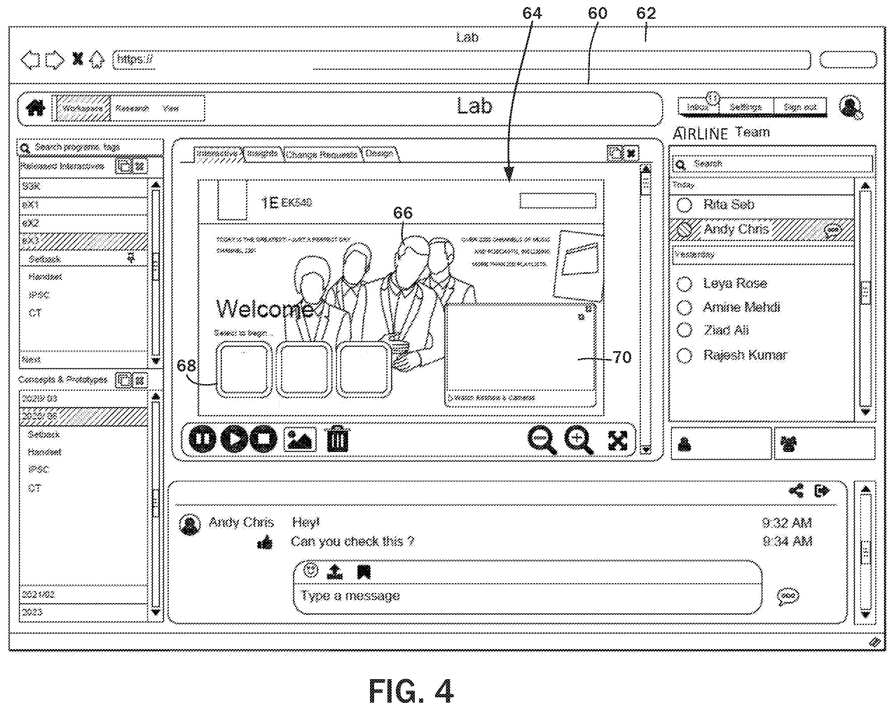

The co-development platform 46 may also include a display terminal emulator 54 that generates an output corresponding to the graphical user interface as provided by the system interaction application. The output may be specifically targeted to the device parameters of the counterpart terminal device 20 that the terminal hardware emulator 50 is emulating, whether the emulated terminal device 20 is a smart monitor, a handset/controller, a portable device such as a passenger PED or a crew terminal device, or any other interactive device that may cooperate with the IFEC system 18. The output of the display terminal emulator 54 is combined with outputs from other components by an interface aggregator 56, and presented to a client via a single unitary client interface 58. In one exemplary embodiment, the client may be a web browser application. Referring to the screen capture of FIG. 4, an output 60 of the client interface 58 is presented within the browser window 62. A main section 64 may be designated for the output of the display terminal emulator 54, and as shown, the graphical user interface to the system interaction application 48 is displayed therein. Furthermore, within the display there may be one or more static graphic elements 66 such as the background image and the “Welcome” text.

The display terminal emulator 54 may be receptive to test inputs to one or more input-receptive graphic elements 68 in the graphical user interface. Such a command to activate the input-receptive graphic element 68 and invoke further functionality associated therewith, may be provided via the browser or browser window 62. This may be achieved via a haptic input in client devices with touch-sensitive displays, or via a mouse click, a keyboard entry, or the like in cursor-driven client devices. The input as captured by the browser may be translated to an input command by the client interface 58, which relays it either directly or by way of the interface aggregator 56 to the display terminal emulator 54. This input command, in turn, is understood to modify the execution of the system interaction application 48 in response, e.g., invoke the functionality corresponding to the input.

In addition to interacting with the different features of the graphical user interface, the system interaction application 48 is receptive to a selection of media content for playback by the display terminal emulator 54. Accordingly, output of the display terminal emulator 54 as shown in FIG. 4 includes a media playback sub-window 70. Again, the playback of the multimedia content is simulated to closely correspond to equivalently playing back the same on the physical counterpart terminal device 20, so that the passenger's experience may be closely replicated. Along these lines, the system interaction application 48 may include additional sub-applications that are executable by the emulated data processor of the terminal hardware emulator 50.

Like the graphical user interface to the system interaction application 48, the sub-applications are also understood to generate outputs and be receptive to inputs that may be provided by direct graphical input or by buttons or other control inputs to a remote controller/handset 28. Similarly, the execution of the sub-application may be modified in response to the provided inputs. These sub-applications include a game sub-application, a vehicle navigation sub-application, and an information presentation kiosk sub-application, among many others. Those having ordinary skill in the art will recognize the various sub-applications that may be offered in the IFEC system 18.

Referring again to the block diagram of FIG. 2, the co-development platform 46 incorporates a graphical user interface editor 72 by which various interactives 74 utilized in the graphical user interface to the system interaction application 48 may be modified.

Referring to the screen capture of FIG. 4, an output 60 of the client interface 58 is presented within the browser window 62. The main section 64 displays the output from the graphical user interface editor 72, and includes one or more interface element settings 76 that are modifiable by the user. These settings include the selection of the various interactives 74 utilized in the graphical user interface, its positioning within the layout thereof, accompanying text, typeface selections, and so on. Once these changes are committed, the entire package of interactives 74 and related settings may be passed to the system interaction application 48 that re-generates the graphical user interface and update the output view to the display terminal emulator 54. The screen capture of FIG. 4 shows one example implementation of an output from the graphical user interface editor 72, and is not intended to be limiting.

Again, in the typical fleet of an airline, different IFEC systems and versions thereof may be deployed on the aircraft at any given time, and the co-development platform 46 is capable of managing the update process with respect to the interactives 74 therefor. In a first side section 78, there is a listing 80 of interactives organized in a nested outline of IFEC product lines/versions, including the S3K system, the eX1 system, eX2 system, and the eX3 system offered by Panasonic Avionics Corp. of Lake Forest, Calif. Within each product line, there may be separate interactives for each component that has a modifiable graphical user interface, including the smart monitor or seatback unit, the handset, a handheld tablet (IPSC), a crew terminal, and so forth.

The listing 80 is understood to be the released interactives 74, that is, those that have been deployed to operating IFEC systems 18. Prototypes and future concepts may also be developed and managed within the co-development platform 46, and so in a second side section 82, there may also be a listing 84 of prototype and concept interactives 74 organized similarly in a nested outline of future deployment dates and each component with modifiable graphical user interfaces. New interactives may be added and unneeded interactives may be deleted from the listing 80.

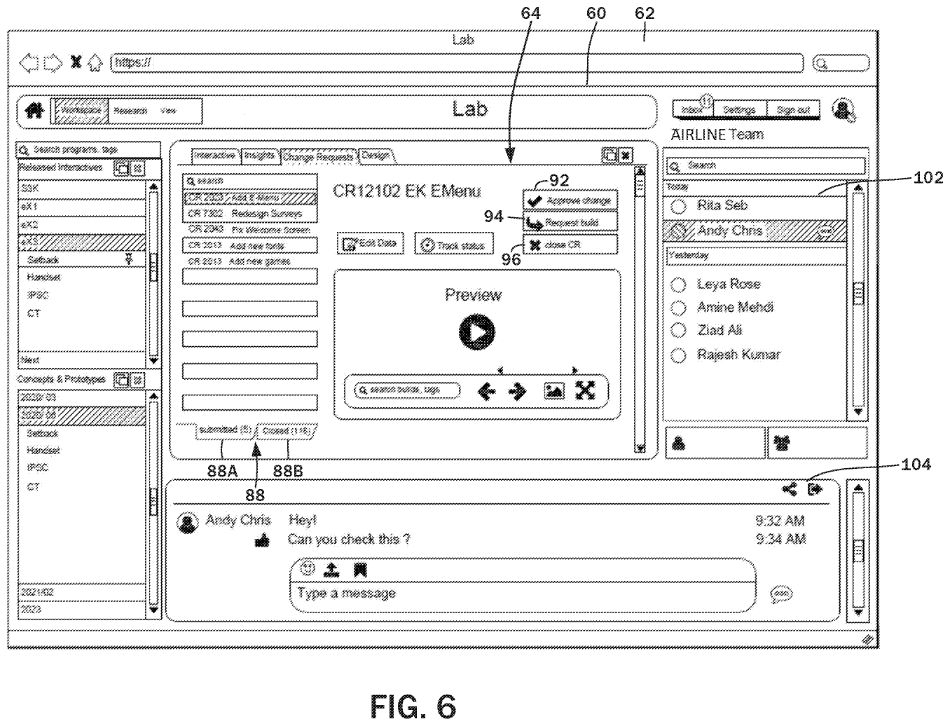

Various personnel from both the airline/carrier and the IFEC system provider may be involved in the maintenance and updating of the interactives 74, with each being responsible for different facets of the process. One aspect involves a certain subset of users making requests to modify the interactives 74, which are then acted upon by other users. Thus, the co-development platform 46 may include a change request processor 86 that is receptive to action items relating to revisions to the interactives 74, as well as responses to those action items. Referring to the screen capture of FIG. 6, another output 60 of the client interface 58 is presented within the browser window 62. The main section 64 displays the output from the change request processor 86 that includes a listing 88 of individual action items that are separated into a submitted tab 88a and a closed tab 88b as combined with the outputs of the other components of the co-development platform 46 by the interface aggregator 56. The listing shows a unique identifier for the particular action item, along with a brief description for the same. The main section 64 further includes a detail sub-pane 90 with an approve change button 92, a request build button 94 that commits the staff resources to make the requested change, and a close change request button 96. Details of the action item or change request may be edited, and its progress may also be reviewed. Within a preview sub-pane 98, an example graphical user interface display showing the change requested may be displayed.

The screen capture of FIG. 6 shows one example implementation of an output from the change request processor 86, and is not intended to be limiting.

Referring back to the block diagram of FIG. 2, the co-development platform 46 further includes a collaborative user message exchange 100 that is receptive to messages from one or more users logged into the co-development platform 46. As best shown in FIG. 6, the output 60 of the client interface 58 further includes a user listing 102 of all personnel involved in the interactives maintenance and updating process. In a message sub-window 104, messages exchanged amongst the group of users shown in the user listing 102 may be presented. Alternatively, messaged exchanged with a specific user may also be presented in the message sub-window 104. The outputs of the collaborative user message exchange 100, for example, the user listing 102 and the message sub-window 104 are understood to be combined by the interface aggregator 56 to present these to the user in a single, unitary interface.

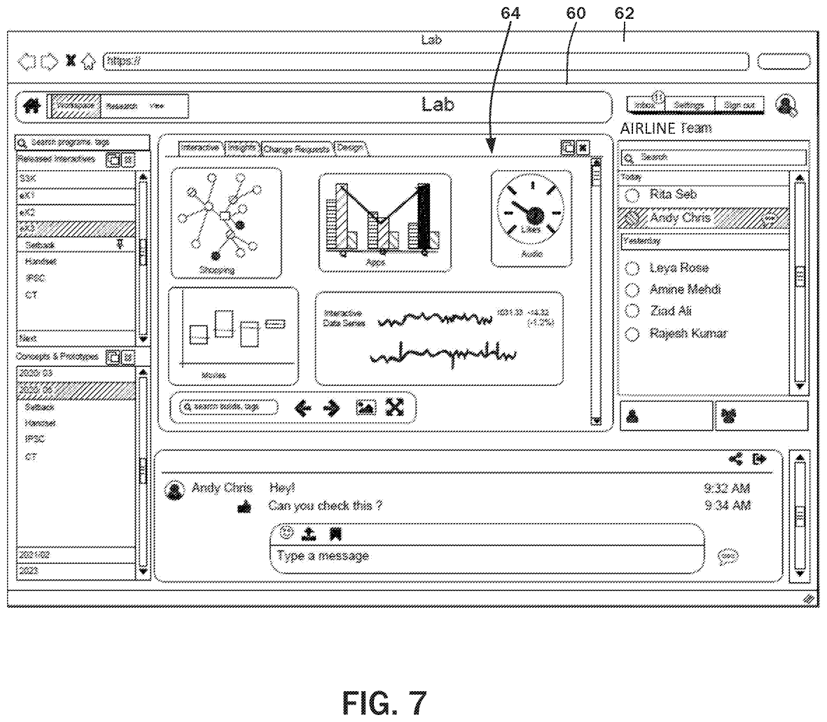

The co-development platform 46 also includes various customer feedback dashboards that assist personnel with updating the interactives 74. One embodiment contemplates an analytics processor 106 that collects usage data associated with the graphical user interface to the system interaction application 48, and how a passenger utilizes the IFEC system 18 in a production setting. Another embodiment contemplates a survey processor 108 that collects survey data points from the passengers using the graphical user interface to the system interaction application 48. Periodically during use, survey questions may be presented to the user, and the inputs solicited thereby may be recorded by the survey processor 108. The interface aggregator 56 may present the aggregated analytics data from the collected usage data, and/or the aggregated survey results generated from the collected survey data points. As shown in FIG. 7, the aggregated analytics data and the aggregated survey results may be in the output 60 of the client interface 58, which is presented within the browser window 62. The main section 64 may incorporate various charts and graphs of the aggregated analytics data and survey results.

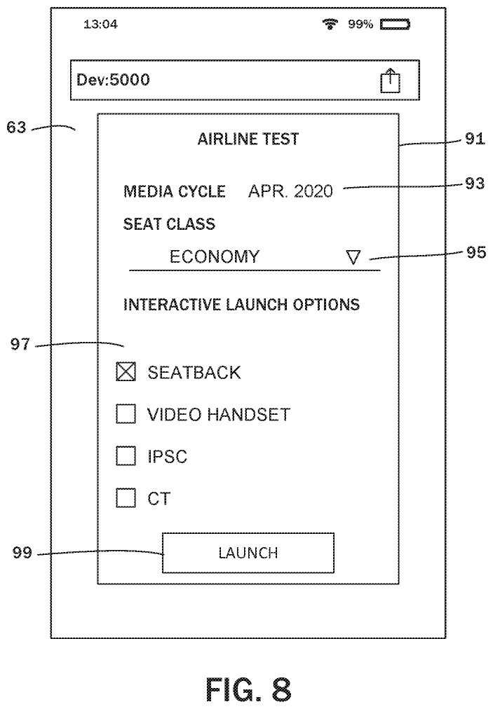

As indicated above, a variety of personnel may be involved in the development, updating, as well as testing of the interactives 74. Although a test output may be shown within the browser window 62, testing may also be initiated from a mobile browser such as that shown in FIG. 8. In further detail, a mobile device or the like with a smaller display screen may be used to access the co-development platform 64, and an example browser window 63 may be shown. The same, albeit pared down set of options and information may be presented within a test initiation screen 91. Version data 93 for the interactives 74 may be shown, and the specific ones for a given seat class may be selected via a pulldown menu 95. Additionally, listing 97 of interactives for each passenger-accessible device including the seatback monitor, the video handset, handheld tablet, crew terminal, and the like may be selected via the corresponding checkboxes. Activating the launch button 99 is understood to invoke a test output of the selected interactives 74. Although the foregoing description of the test initiation screen 91 was in the context of a limited display screen of a mobile device, a similar one may be presented via a other client interfaces 58 that are presented on, for example, desktop displays and so on.

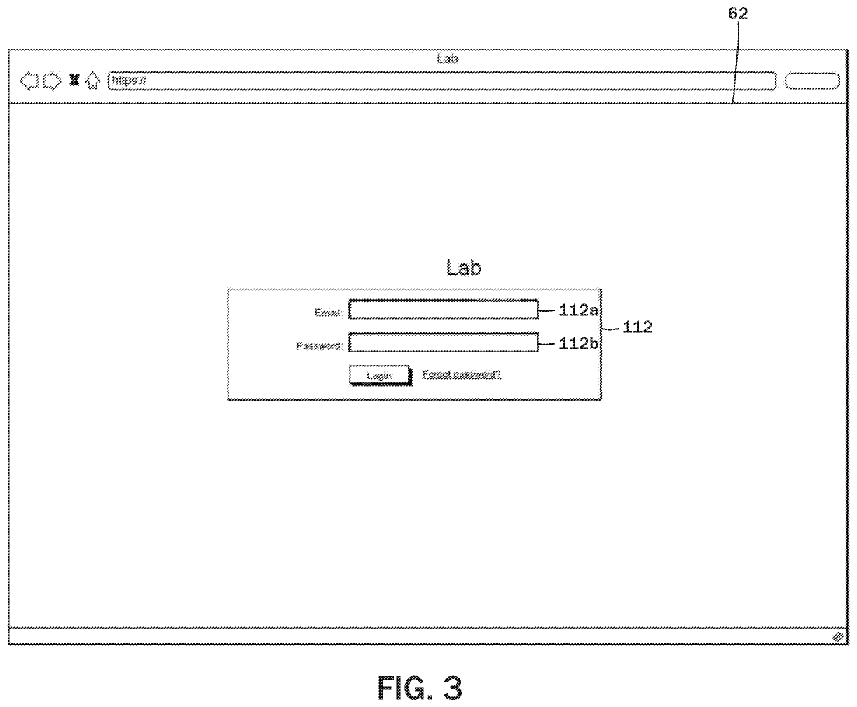

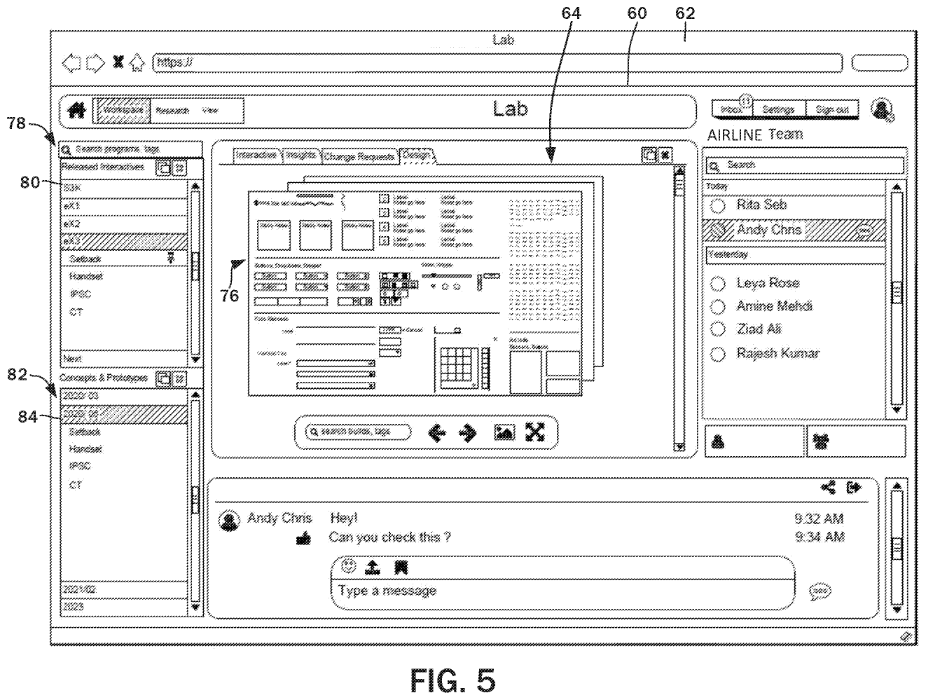

The embodiments of the co-development platform 46 contemplate one or more of the outputs from the graphical user interface editor 72, the change request processor 86, the collaborative user message exchange 100, the analytics processor 106, and the survey processor 108 to be integrated into a single client interface output. Different embodiments may omit certain outputs, or include additional inputs, and the foregoing examples illustrated in the screen captures of FIGS. 4-8 are presented by way of example only and not of limitation. Furthermore, because use cases of different users may vary according to their respective roles in the process, the specific combination of aggregated outputs may likewise vary. For example, the functions needed by airline personnel may differ from those needed by account managers of the provider of the co-development platform 46, and still different from program managers, interactives builders, testers, and general system administrators. Permissions to access or invoke certain functionalities in any of the foregoing components may also be varied depending on the classification of the user. These permissions may be enforced via a test user access controller 110 that defines access privilege levels for each user. FIG. 3 is a screen capture of an exemplary login prompt 112 including an e-mail address field 112a and a password field 112b that is presented within the browser window 62.

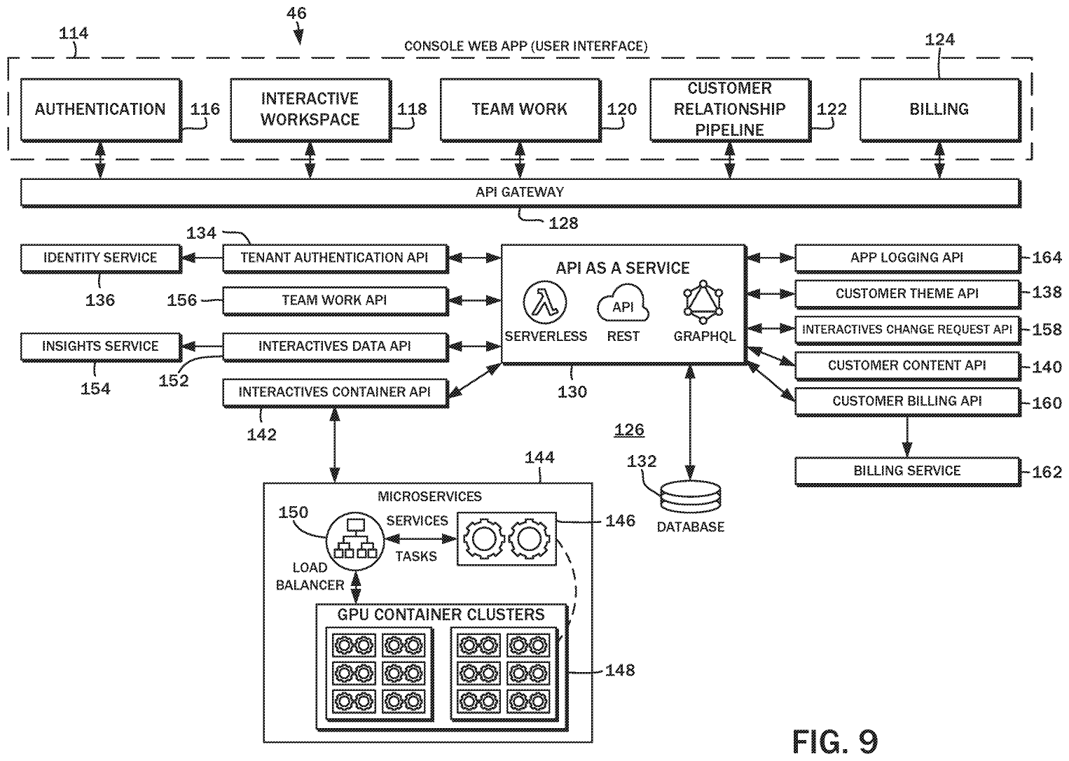

Referring to the block diagram of FIG. 9, in accordance with another embodiment of the present disclosure, and at a different level of detail than discussed above in the context of the block diagram of FIG. 2, the co-development platform 46 may be implemented in part as a web application client console 114 including an authentication module 116, an interactive workspace module 118, a team work module 120, a change request pipeline module 122, and a billing module 124. These modules are understood to be the front end of the co-development platform 46 that interfaces with a back end 126 that is comprised of various application programming interfaces (APIs), all of which cooperate with the modules via an API gateway 128. The APIs may be provided as a service 130 without a specific server (e.g., serverless), and implemented in accordance with a Representational State Transfer (REST) architecture or as GraphQL APIs. The APIs rely upon a separate database 132 for storing all platform data.

With the authentication module 116, users may sign in and sign out of accounts that define the access privilege levels for the user. Additionally, new users may be invited or added by the administrator, and such enrollment process is understood to invoke functions implemented in the authentication module 116. In one embodiment, the authentication module 116 may call a tenant authentication API 134, which in turn may call an identity service 136 to validate user-provided credentials.

The interactive workspace module 118 provides the functionality for the user to navigate to specific interactives, submit changes thereto, and preview selected builds of interactives. As discussed above, the interactives are organized according to IFEC system and/or aircraft identifiers, with such data being retrieved by calling a customer theme API 138 and a customer content API 140. The rendering of the interactives 74 may involve calling an interactives container API 142, which utilizes a virtualization system/processing microservices 144 that offloads graphics processing functions to one or more simulated processor units 146 that are arranged in clusters 148. The containers making up the clusters 148 may be implemented with Docker containers or LXC/LXD containers, and communication between client interface 58 and the containers may be implemented with WebSockets, WebGL, WebAssembly, VNC, and Android Cloud Emulators. A load balancer 150 receives the processing requests from the interactives container API 142, which distributes the processing burden to the cluster 148. With the interactive workspace module 118, it is also possible to visualize insights gained from usage and survey data that pertain to the interactives. This may involve calling an interactives data API 152, which in turn may call one or more insights services 154 that are sources of the usage and survey data.

As changes to the interactives are viewed and modified, the involvement of additional users may invoke the team work module 120. Various collaboration features are implemented therein, including team discussions, as well as downloading uploading assets that may be used to generate the interactives. The functionalities may be implemented in a team work API 156

Following one or more iterative cycles of revising the interactives of the graphical user interface, customer feedback and approval may be handled by the change request pipeline module 122. This module is understood to accept submissions of change requests, and includes features to track and follow-up on change requests. There are also modalities for visualizing and approving the change requests, also as discussed above. These functionalities may be accessed by invoking an interactives change request API 158.

Lastly, some embodiments of the present disclosure contemplate offering the co-development platform to airline customers as a Software as a Service (SaaS) with the billing module 124 providing cost estimates and setting different payment plans. The functionalities associated with billing may be invoked by calling a billing API 160, some aspects of which may involve using a billing service 162. The billing module 124 may also call an application logging API 164 that tracks the usage of the co-development platform for determining fees. The application logging API 164 may also be called by other modules where usage history information may be beneficial, e.g., tracking changes made to the interactives, etc.

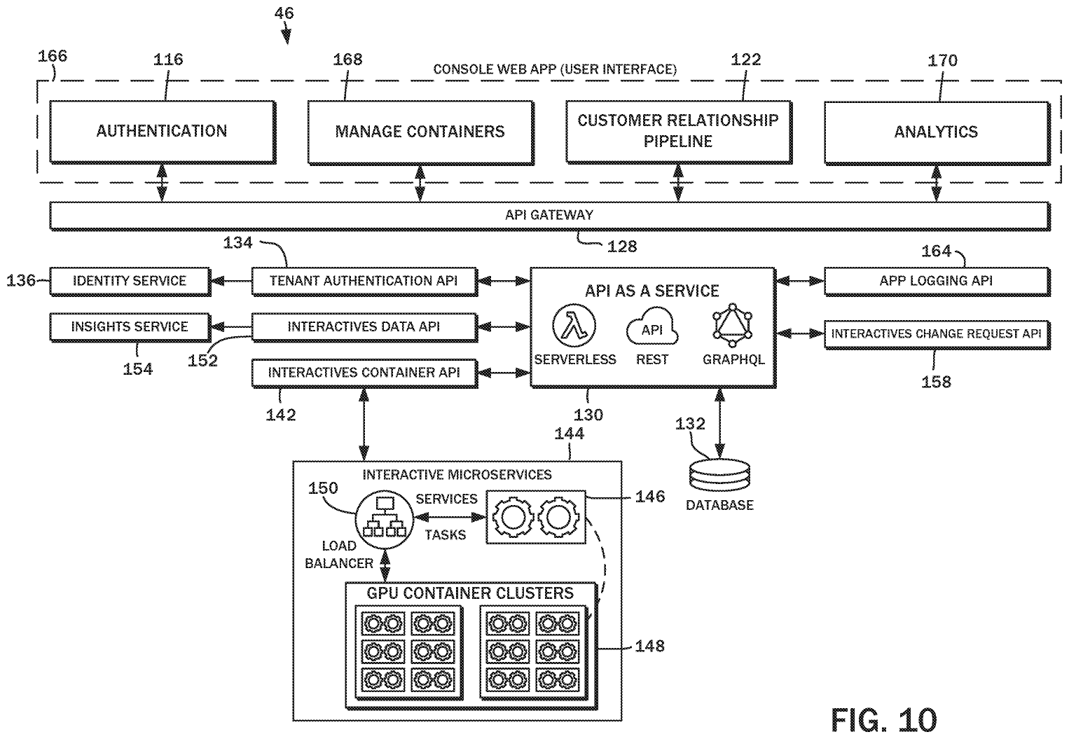

As shown in the block diagram of FIG. 10, the co-development platform 46 is understood to additionally implement a web application administration console 166 that includes the aforementioned authentication module 116, a container management module 168, the change request pipeline module 122, and an analytics module 170. The provider of the co-developer platform, including various personnel such as account managers, program managers, interactive builders, testers, and general system administrators may utilize the administration console 166 to track and facilitate the interactives update process.

From an administration standpoint, the authentication module 116 may call the tenant authentication API 134 to set up enterprise-wide single sign-on, and new customer user management functions. As in the client console 114, the tenant authentication API may use the identity service 136 for its data and certain functions needed to fulfill its designated roles.

Administration of the co-development platform 46 may also involve building new container images, deleting unused container images, and testing interactive containers. These functionalities are provided by the container management module 168, which invokes the interactives container API 142 as discussed above in the context of the client console 114.

There are certain administrative tasks associated with change requests as well, so the change request pipeline module 122 also incorporates administration features, including updating of change requests, initiating a field release of interactives, as well as basic customer relationship management facilities. The change request pipeline module 122 may call upon the change request API 158 for such functions and storing/retrieving the data associated therewith.

A variety of analytics may be performed on usage data collected through the co-development platform 46 for a single customer, or across multiple customers. A usage dashboard that aggregates usage information may be provided via the analytics module 170, which in turn calls the application logging API 164.

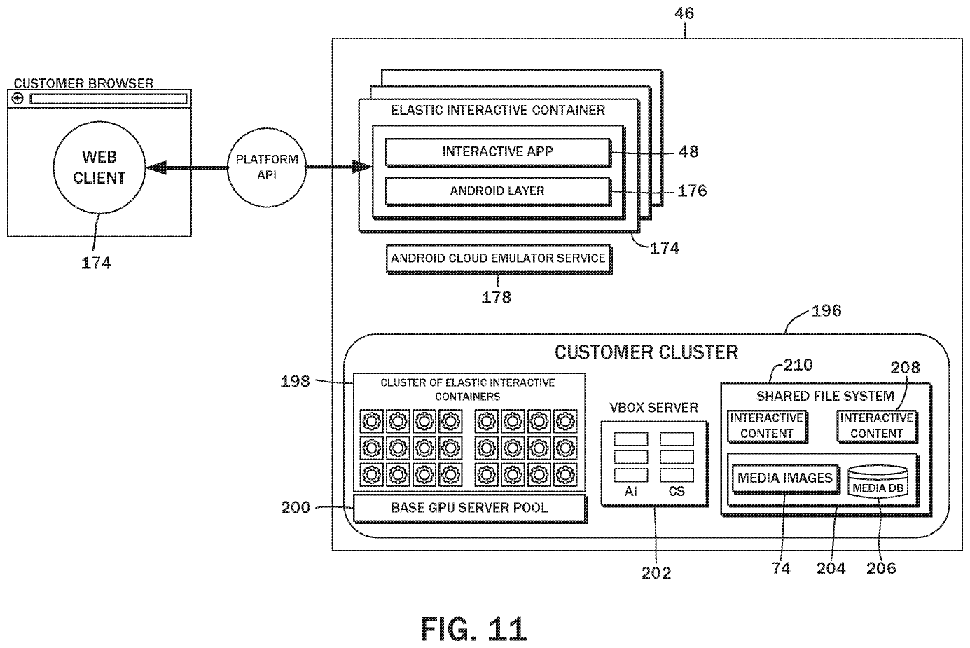

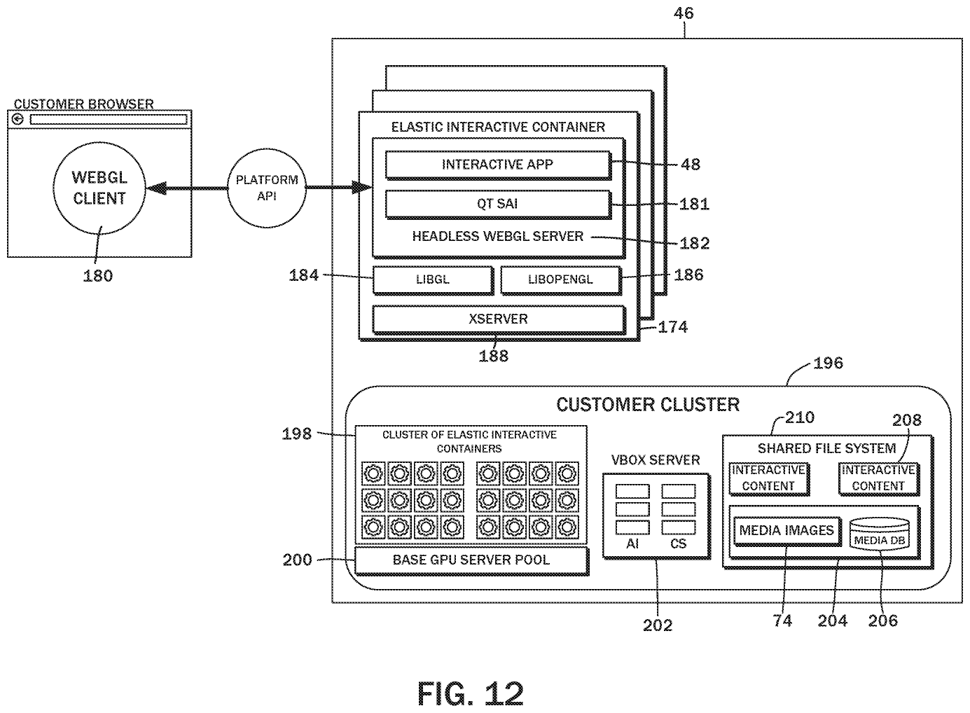

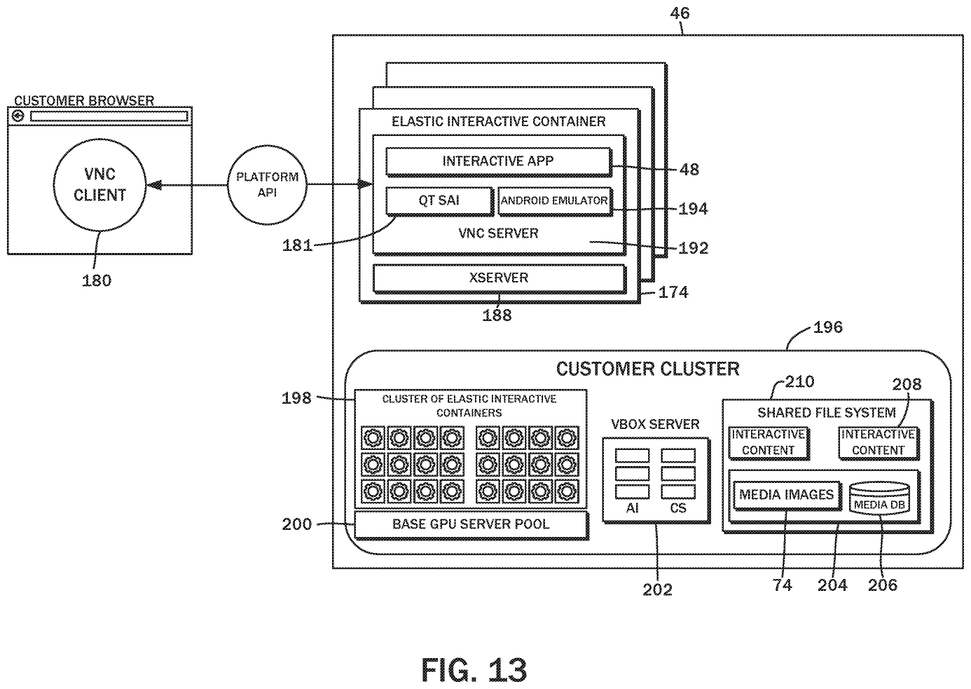

The co-development platform 46 is contemplated for implementation on a cloud/virtualization platform, with the graphical user interface to the system interaction application 48 being emulated by a cloud-based virtual machine. The passing of output data between the emulator and the web browser or client interface may be achieved with one of several known web technologies and protocols. The block diagrams of FIG. 11, FIG. 12, and FIG. 13 illustrate these embodiments.

FIG. 11 shows an exemplary implementation for a standard web browser client 172. The co-development platform 46 includes one or more elastic interactive containers 174, each of which includes an Android interface layer 176 and the system interaction application 48 that is executed on an Android cloud emulator service 178.

FIG. 12 shows an exemplary implementation for a web browser with the Web Graphics Library (WebGL) application programming interface being enabled. Again, the co-development platform 46 includes one or more elastic interactive containers 174, each including the system interaction application 48. The application may rely upon the QT graphical user interface widget toolkit 181, and being executed on a headless WebGL server 182. This server, in turn, may utilize the libGL library 184 that provides the interface to the OpenGL library 186. As will be recognized, the OpenGL library is an application programming interface for graphics rendering that, among other uses, called to implement QT widgets. These libraries are hosted on an X-window display server 188.

FIG. 13 shows an exemplary implementation for a web browser with a Virtual Network Computing (VNC) screen sharing client 190. The co-development platform 46 includes one or more elastic interactive containers 174, each including the system interaction application 48. The application may run on a VNC server 192, which also utilizes the QT graphical user interface widget toolkit 181, along with an Android emulator 194. The VNC server 192 runs atop the X-window display server 188. As an alternative implementation to that illustrated by FIG. 13, an open standard such as WebAssembly may be used. WebAssembly is designed as a portable target for compilation of high-level languages such as C, C++, Rust and others, enabling deployment for client and server applications.

Regardless of the specifics of the client-side emulation that is implemented, the co-development platform 46 dedicates a customer cluster 196 on the virtualization system. In accordance with various embodiments, there are a cluster of elastic interactive containers 198 that is running on a pool of base graphic processing units 200. The servers implementing the graphic processing units may be managed by a hypervisor 202, which in one embodiment is an Oracle Virtual Box server. The customer cluster 196 also includes a repository 204 for the interactives 74 including a database system 206. Additionally, the multimedia content or interactive content 208 is stored together with the repository 204 in a shared file system 210.

The particulars shown herein are by way of example and for purposes of illustrative discussion of the embodiments of the co-development platform 46 and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A co-development platform for a graphical user interface to a system interaction application of a terminal device for a vehicle entertainment system, the co-development platform comprising:
a terminal hardware emulator including an emulated data processor executing software instructions corresponding to the system interaction application;
a display terminal emulator generating an output corresponding to the graphical user interface and selectively targeted to device parameters specific to the terminal device, the display terminal emulator being receptive to test inputs to one or more input-receptive graphic elements in the graphical user interface, with the test inputs being translated to inputs to the emulated graphical user interface processed by the terminal hardware emulator to modify the execution of the system interaction application in response;
a graphical user interface editor including one or more interface element settings modifiable by a given one of one or more logged in test users; and
a test user access controller defining access privilege levels for each of the test users, a given one of the test users being selectively restricted and permitted to access one or more functionalities of the display terminal emulator and the graphical user interface editor based upon the associated access privilege levels.

2. The co-development platform of claim 1, an interface aggregator presenting the display terminal emulator and the graphical user interface editor within a single unitary client interface accessible following the test user being logged in by the test user access controller.

3. The co-development platform of claim 2, further comprising a change request processor receptive to action items pertaining to revisions to the graphical user interface, the interface aggregator further presenting the change request processor within the single unitary client interface.

4. The co-development platform of claim 2, further comprising a collaborative user message exchange receptive to messages from one or more test users, the interface aggregator further presenting the collaborative user message exchange within the single unitary client interface.

5. The co-development platform of claim 2, further comprising an analytics processor collecting usage data associated with the graphical user interface, the interface aggregator further presenting aggregated analytics data derived from the collected usage data within the single unitary client interface.

6. The co-development platform of claim 2, further comprising a survey processor collecting survey data points from users of the graphical user interface, the interface aggregator further presenting aggregated survey results generated from the collected survey data points within the single unitary client interface.

7. The co-development platform of claim 1, wherein the graphical user interface includes one or more static graphic elements.

8. The co-development platform of claim 1, wherein the system interaction application is receptive to a selection of a media content for playback on the display terminal emulator.

9. The co-development platform of claim 1, wherein the system interaction application includes an interactive sub-application executable by the emulated data processor of the terminal hardware emulator, the sub-application generating outputs and receptive to control inputs modifying the execution thereof in response to the control inputs.

10. The co-development platform of claim 9, wherein the interactive sub-application is selected from a group consisting of: a game sub-application, a vehicle navigation sub-application, and an information presentation kiosk sub-application.

11. The co-development platform of claim 1, wherein the terminal hardware emulator is remotely hosted on a virtual machine with a hardware abstraction layer instantiated by a virtual machine manager according to simulated hardware component definitions corresponding to an equivalent physical configuration of the terminal device.

12. The co-development platform of claim 11, wherein the terminal device is selected from a group consist of: a seatback smart monitor, a handset, a tablet computing device, and a vehicle crew terminal device.

13. The co-development platform of claim 12, wherein one of the device parameters is a set of display parameters defining display capabilities of the terminal device, the output corresponding to the graphical user interface being selected for the set of display parameters.

14. The co-development platform of claim 12, wherein one of the device parameters is an operating system running on the terminal device, executable instructions associated with the output corresponding to the graphical user interface being specific to the operating system.

15. An in-flight entertainment terminal user interface virtualized development system, the system comprising:
a virtual machine instance simulating physical hardware components of a terminal to execute software instructions corresponding an in-flight entertainment system interaction application, the virtual machine instance being defined by device parameters specific to the terminal;
a display emulator connected to the virtual machine instance, display outputs corresponding to a graphical user interface of the in-flight entertainment system interaction application as generated by the virtual machine instance being presented by the display emulator, the display emulator being receptive to test user inputs to one or more input-receptive graphic elements in the graphical user interface, the test user inputs being relayed to the virtual machine instance to modify execution of the in-flight entertainment system interaction application;
a virtual machine access controller regulating access to the virtual machine instance by one of a plurality of test users each associated with an account with predefined access privilege levels; and
a testing platform connected to the virtual machine instance to deploy interactive elements of the graphical user interface for the in-flight entertainment system interaction application to be displayed by the display emulator.

16. The system of claim 15, further comprising a graphical user interface editor including one or more interface element settings modifying a configuration option of at least one of the interactive elements.

17. The system of claim 16, further comprising an interface aggregator presenting the display emulator and the graphical user interface editor within a single unitary client interface.

18. The system of claim 15, wherein the in-flight entertainment terminal is selected from a group consist of: a seatback smart monitor, a handset, a tablet computing device, and a vehicle crew terminal device.

19. The system of claim 15, wherein one of the device parameters is a set of display parameters defining display capabilities of the terminal device, the output corresponding to the graphical user interface being selected for the set of display parameters.

20. The co-development platform of claim 12, wherein one of the device parameters is an operating system running on the terminal, executable instructions associated with the display outputs corresponding to the graphical user interface being specific to the operating system.
